(19) United States
(12) Patent Application Publication
(10) Pub. No.: US 2002/0175935 A1
(43) Pub. Date: Nov. 28, 2002

(54) Loading advertisements in a Web page and displaying a Web page

(75) Inventors: Qianying Wang, Stanford, CA (US); Jingtao Wang, Beijing (CN)

Correspondence Address: IBM CORPORATION, INTELLECTUAL PROPERTY LAW DEPT., P.O. BOX 218, YORKTOWN, NY, 10598, US

(73) Assignee: International Business Machines Corporation, Armonk, NY

(21) Appl. No.: 10/098,910

(22) Filed: Mar. 14, 2002

(30) Foreign Application Priority Data
Mar. 27, 2001 (CN) 01112017.7

(51) Int. Cl. G09G 5/00

(52) U.S. Cl. 345/738; 710/1

(57) ABSTRACT

Provides a proxy server for loading advertisements in a Web page. An example embodiment includes: an image extractor for obtaining original image data from an original image file included in an original Web page; an image file generator for generating a new image file into which the original image data, display control parameters of the original image data, advertisement image data of an advertisement image, and display control parameters of the advertisement image are integrated, wherein the display control parameters of the original image and the display control parameters of every advertisement image are used to define how long the original image and corresponding advertisement image are displayed; and a Web page modifying device for replacing said original image file with said new image file in said Web page. A method of displaying a Web page, loading advertisements in a Web page, and an apparatus therefore are also provided.

### FIELD OF INVENTION

This invention relates to a system and method for broadcasting advertisements on the Internet. More particularly, this invention relates to a system and method for loading invisible advertisements in a Web page based on the concept of sensory memory.

### BACKGROUND OF THE INVENTION

Currently, one of the major profit sources for Internet web sites is advertisement fee. Many web site owners are complaining the valid space for advertisement is limited and thus their profit source is limited. But at the same time, many Internet users complain there are too many advertisements on the Internet and these advertisements often distract their attention and cause inconvenience. Therefore, there is a need to solve the problem of how to broadcast advertisements effectively on the Internet without significantly distracting the attention of the user.

### SUMMARY OF THE INVENTION

An aspect of this invention is to provide a solution to the problem of broadcasting advertisements on the Internet efficiently. In an example embodiment, this invention provides a method of loading advertisements in a Web page, comprising steps of: obtaining original image data from an original image file included in an original Web page; integrating the original image data, display control parameters of the original image data, advertisement image data composing at least two advertisement images, and display control parameters of the advertisement image into a new image file, wherein the display control parameters of the original image and the display control parameters of every advertisement image are used respectively to determine how long the original image and which corresponding advertisement image are displayed within every second, or occurrence of a predetermined time interval. [e.g. 0.1-20 seconds], or other interval.; and modifying the Web page by replacing the original image file with the new image file with special format.

An aspect of this invention is to provide a method of displaying a Web page, comprising steps of: obtaining a Web page including at least one image file, the Web page containing data of at least two images and display control parameters of each image; alternately displaying each image for a duration that corresponds to the display control parameters of the image within every second., or occurrence of a predetermined time interval. [e.g. 0.1-20 seconds], or other interval.

This invention further provides a proxy server for loading advertisements in a Web page, characterized by comprising: an image extractor, for obtaining original image data from an original image file included in an original Web page; an image file generator, for generating a new image file, and for integrating the original image data, display control parameters of the original image data, advertisement image data of at least one advertisement image, and display control parameters of the advertisement image into the new image file, wherein the display control parameters of the original image and the display control parameters of every advertisement image are respectively used to define how long the original image and which corresponding advertisement image are displayed within every second; and a Web page modifying device, for modifying the Web page by replacing the original image file with the new image file.

This invention still further provides a method of displaying a Web page, characterized by comprising steps of: obtaining a Web page including at least one image file, the image file containing data of at least two images and display control parameters of each image; alternately displaying each image for a duration that corresponds to the display control parameters of the image within every second, or other time period.

This invention further provides a computer-readable medium for recording programs, characterized in that the computer programs recorded thereon are used for performing steps of: obtaining original image data from an original image file included in an original Web page; integrating the original image data, display control parameters of the original image data, advertisement image data of at least one advertisement image, and display control parameters of the advertisement image into a new image file, wherein the display control parameters of the original image and the display control parameters of every advertisement image are respectively used to define how long the original image and corresponding advertisement image are displayed within every second, or occurrence of a predetermined time interval. [e.g. 0.1-20 seconds], or other interval; and modifying the Web page by replacing the original image file with the new image file.

This invention moreover provides a computer-readable medium for recording programs, characterized in that the computer programs recorded thereon are used for performing steps of. obtaining a Web page including at least one image file, the image file containing data of at least two images and display control parameters of each image; and alternately displaying each image for a duration that corresponds to the display control parameters of the image within every second.

The proxy server for loading advertisements according to this invention can automatically detect where the image files are in the Internet and load the prepared advertisement image. Of course, the advertisement proxy server according to this invention also supports manually image generating so as to modify the layout and time interval of each image.

The Web page displaying apparatus of this invention can be produced as a plug-in to provide support for displaying of the image file embedded with invisible advertisement. When the user first browses web pages containing the invisible advertisement, the plug-in can be downloaded automatically and installed to the client browser in a transparent way.

The advertisement loaded by the system and method according to this invention is generally invisible to the Internet surfer, which means the Internet surfer will not see the broadcast advertisement so that their attention will not be distracted, while the advertisement effect being achieved at the same time. Therefore, the system and method according to this invention can exploit more advertisement space in the Internet as well as expand advertisement profit sources of the web site.

### BRIEF DESCRIPTION OF THE DRAWINGS

These and other objects, features, and advantages of the present invention will become apparent upon further consideration of the following detailed description of the invention when read in conjunction with the drawing figures, in which:

FIG. 1 is a flowchart illustrating the method of loading advertisements in a Web page according to this invention;

FIG. 2 is a flowchart illustrating the Web page displaying method according to this invention;

FIG. 3 is a sketch diagram illustrating the composition of the proxy server for loading advertisement in a Web page according to this invention; and

FIG. 4 is a sketch diagram illustrating the construction of the Web page displaying apparatus according to this invention.

### DESCRIPTION OF THE INVENTION

In mnemonic psychology, there are three kinds of memories of human being, which are sensory memory, short-term memory and long-term memory. Sensory memory means that very short memory event is captured by eye and brain pallium, but not necessarily be processed into short term or long term memory for storage. In 1960s, famous psychologist George Sperling proved the existence of sensory memory. His partial report experiment also proved that although the time span of sensory memory is short (usually at the level of tens of milliseconds), the information volume which can be captured by sensory memory is significant enough. With the development of neuro-physiology, psychologists have better understanding about how sensory memory stimulates the neural networks and proved that frequent sensory memory can leave strong impression as well.

Everybody has such experience that a rapid sequence of frames results in the impression of motion. This is due to the eyes visual delay mechanism, i.e., around a tenth of a second is needed before the retina send the captured information to the brain. In film production, 24 discrete frames generate one second of motion movie. Thus, since the time span of each frame (40ms) is less than this visual delay, the images projected on the retina are overlapped to create a continuous motion illusion.

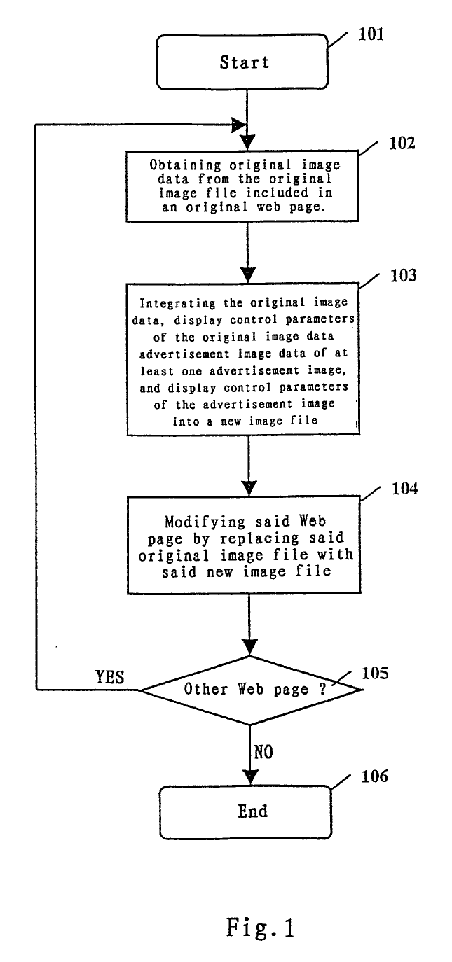

Based on the above understanding of mnemonic psychology and neuro-physiology, we propose a method of loading advertisements in a Web page shown in FIG. 1. FIG. 1 is a flowchart illustrating an example of a method of loading advertisements in a Web page according to this invention. The process starts in step 101. In step 102, original image data is obtained from an original image file included in an original Web page. In step 103, the original image data, display control parameters of the original image data, advertisement image data of at least one advertisement image, and display control parameters of the advertisement image are integrated into a new image file, wherein the display control parameters of the original image and the display control parameters of every advertisement image are respectively used to define how long the original image and corresponding advertisement image are displayed within every second. In step 104, the Web page is modified by replacing the original image file with the new image file. In step 105, determining whether other Web pages are needed to be intercepted continuously. If the result of step 105 is yes, the process will turn back to step 102 to intercept other Web pages. If the result of step 105 is no, the process will proceed to step 106 and ends.

According to the above method, the original image may be any moving/still image that is displayable in the Web page or the background image of the Web page. According to the above method, the display control parameters of at least one advertisement image are used to define that the advertisement image is displayed for a duration shorter than visual delay threshold within every second, or other time interval.

The above method can be implemented on an advertisement proxy server, and a step of intercepting the Web page from the Internet is comprised before step 102 and a step of sending the modified Web page to its destination address through the Internet is comprised before step 106. According to the above method, the display control parameters of at least one advertisement image are used to define that the advertisement image is displayed for a duration shorter than visual delay threshold within every second.

Generally, it can be assumed that the Web page including invisible advertisement displays n frames every second. Because the threshold of visual delay is 100 ms, n>10. In these n frames, the (n−1) frames for example are non-advertisement images, the remained one frame is the inserted advertisement frame. Of course, more advertisement image frames may be inserted in theory. The frames number of the inserted advertisement image should not limit the scope of the invention. Because of visual delay, people can only be aware of the frames with time span more than around 100 ms, so the inserted advertisement frame is invisible to the user. But according to the sensory memory, the user can actually capture such a short visual event and captured information will stimulate his/her pallium and leave impression, and thus it achieves the same effect of advertising. For the Web page including an invisible advertisement image, we design a special image format. This image format is not restricted to one embedded image only. In theory, N(N>=2) images can be embedded in this format.

An example of the data structure of the image format in this invention is as follows:

image header information
{

Image header signature
file length
default image pixel depth
default image width and height of the images
default image palette
default transparent color index
Total Number of embedded images N
{

the data offset of image1 in this file
the data checksum of image1
the data offset of image2 in this ifie
the data checksum of image2
the data offset of imageN in this file
the data checksum of image N

}

}
{

image1s display control parameters
image1s data buffer
image2s display control parameters
image2s data buffer
image Ns display control parameters
image Ns data buffer
}
image end info
{

image end signature

}

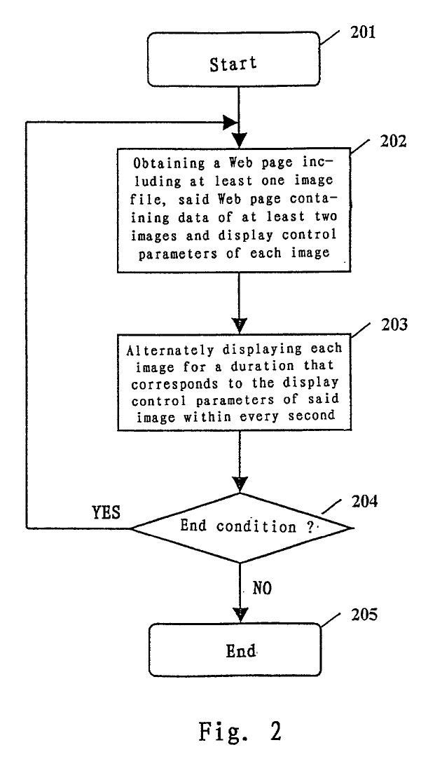

In the above data structure, the display control parameters of each image is used to define in which duration within one second the corresponding image is displayed. The display control parameters can be the frame number as well as the duration beginning from the start point of every second. FIG. 2 is a flowchart illustrating the Web page displaying method according to this invention. The process starts in step 201. In step 202, a Web page including at least one image file is obtained, the image file contains data of at least two images and display control parameters of each image. In step 203, the images are alternately displayed for a duration that corresponds to the display control parameters of the image within every second. In step 204, it is judged whether the end condition is met If the end condition is met, the process will proceed to step 205 and ends. If the end condition is not met, the process will loop back to step 202 to display other Web pages.

According to the above method, one of at least two images is a moving/still image that is displayable in the Web page or the background image of the Web page, and the other is an advertisement image. In step 203 of above method, the advertisement image is displayed for a duration shorter than visual delay threshold within every second. The above method can be implemented on a browser, and a step of receiving the Web page from the Internet is comprised before step 202.

In some embodiments, the above method further comprises a step of modifying display attributes of the advertisement image in real time in order to accommodate other displayed contents, which can improve image displaying quality and avoid flashing.

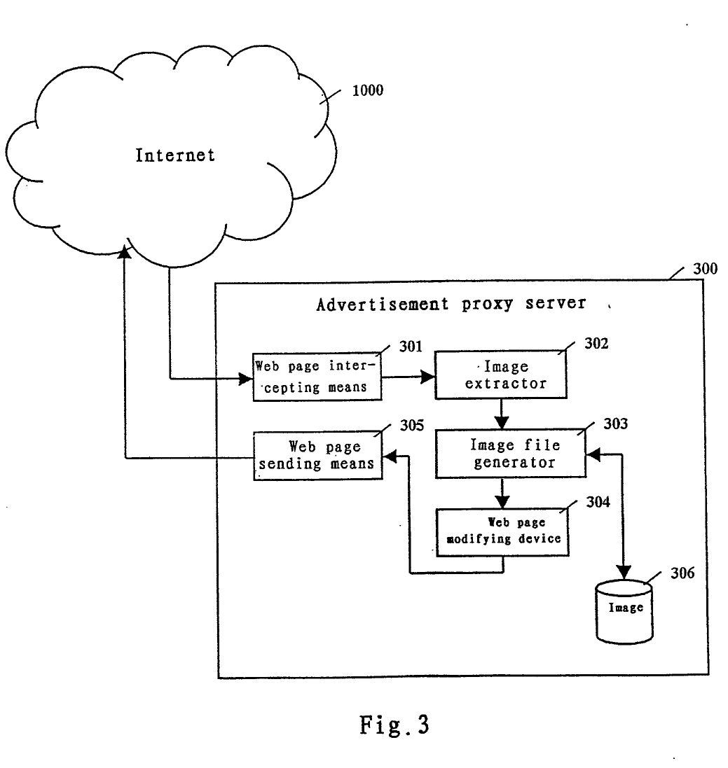

FIG. 3 is a sketch diagram illustrating the construction of the proxy server for loading advertisement in a Web page according to this invention. Number 1000 points to the Internet. Number 300 represents the advertisement proxy server. Number 301 indicates the Web page intercepting means. Number 302 is the image extractor. Number 303 is the image file generator. Number 304 is the Web page modifying device. Number 305 is the Web page sending means. Number 306 is the image storing means. The Web page intercepting means 301 intercepts an original Web page from the Internet 1000. The image extractor 302 obtains original image data from the original image file included in the original Web page. The image file generator 303 generates a new image file in image storing means 306 and integrates the original image data, the display control parameters of the original image data, the advertisement image data of at least one advertisement image, and the display control parameters of the advertisement image into the new image file, wherein the display control parameters of the original image and the display control parameters of every advertisement image are respectively used to define how long the original image and corresponding advertisement image are displayed within every second, or occurrence of a predetermined time interval. [e.g. 0.1-2 seconds], or other interval.. The above advertisement image data of at least one advertisement image and the display control parameters of the advertisement image both can be pre-stored in the image storing means 306. The Web page modifying device 304 modifies the Web page by replacing the original image file with the new image file. The Web page sending means 305 sends the modified Web page to its destination address through the Internet 1000. The image extractor 302 obtains data of any moving/still image from the Web page as the original image data. The obtained original image data can also be the background image data of the Web page.

The display control parameters of at least one advertisement image are used in the image file generator 302 to define that the advertisement image is displayed for a duration shorter than visual delay threshold within every second.

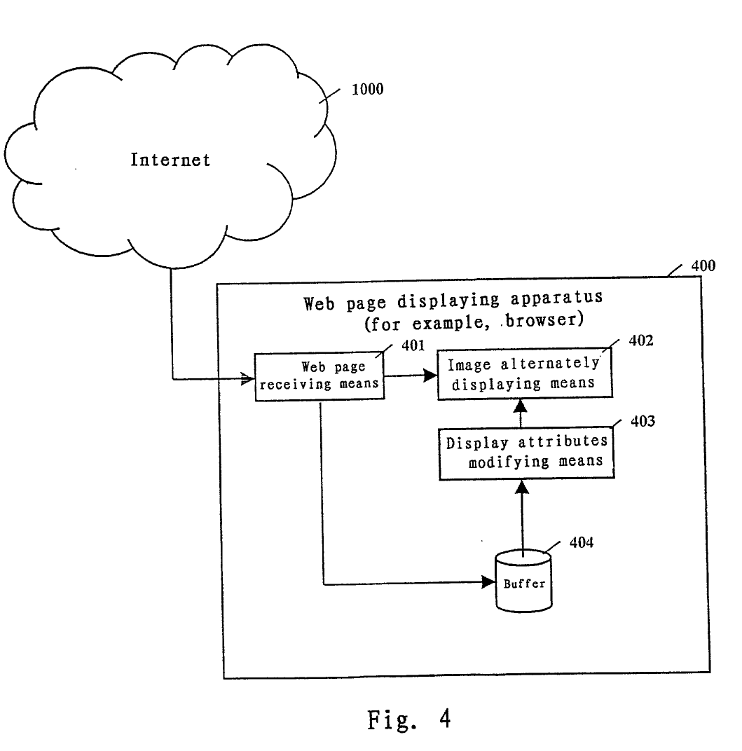

FIG. 4 is a sketch diagram illustrating the construction of the Web page displaying apparatus according to this invention. Number 1000 points to the Internet Number 400 represents the Web page displaying apparatus of this invention. Number 401 indicates the Web page receiving means. Number 402 is the image alternately displaying means. Number 403 is the display attributes modifying means and number 404 is the Web page buffer. The Web page receiving means 401 obtains a Web page including at least one image file, the image file contains data of at least two images and display control parameters of each image. Herein, one of at least two images is a moving/still image that is displayable in the Web page or the background image of the Web page and the other is an advertisement image. As explained in the previous paragraphs with reference to FIG. 3, the received Web page is the one modified by the advertisement proxy server 300. There is an embedded advertisement image in this modified Web page.

If the Web page displaying apparatus is embodied as a browser, the Web page receiving means 401 is used to receive the Web page from the Internet 1000. The image alternately displaying means 402, alternately displays each of the images for a duration that corresponds to the display control parameters of the image within every second. When the invisible advertisement is embedded, the image alternately displaying means 402 displays the advertisement image for a duration shorter than visual delay threshold within every second. Because advertisement image being displayed may have different display attributes from the images displayed before or after the advertisement image, flashing may happen in partial areas. In order to avoid the flashing, the display attributes modifying means 403 may be set to modify the display attributes of the advertisement image in real time in order to accommodate other displayed contents. Of course, the display attributes modifying means 403 is not mandatory.

Through the above description, two computer-readable mediums provided by this invention for recording programs will become more understandable.

In an example embodiment, the first computer-readable medium records programs for performing steps of: obtaining original image data from an original image file included in an original Web page; integrating the original image data, display control parameters of the original image data, advertisement image data of at least one advertisement image, and display control parameters of the advertisement image into a new image file, wherein the display control parameters of the original image and the display control parameters of every advertisement image are respectively used to define how long the original image and corresponding advertisement image are displayed within every second; modeling the Web page by replacing the original image file with the new image file.

The above original image can be any moving/still image that is displayable in the Web page, for example the background image of the Web page. The display control parameters of the above at least one advertisement image are used to define that the advertisement image is displayed for a duration shorter than visual delay threshold within every second. The above first medium for recording programs enables an advertisement proxy server to implement the above computer program so as to realize the function of automatically loading advertisement in a Web page. The second computer-readable medium records programs for performing steps of: obtaining a Web page including at least one image file, the image file containing data of at least two images and display control parameters of each image; alternately displaying each image for a duration that corresponds to the display control parameters of the image within every second, or occurrence of a predetermined time interval. [e.g. 0.1-20 seconds], or other interval.

One of the above at least two images is a moving/still image that is displayable in the Web page, for example the background image of the Web page and the other one is an advertisement image.

In an embodiment the above step of alternately displaying each image includes: displaying the advertisement image for a duration shorter than visual delay threshold within every second, or occurrence of a predetermined time interval. [0.1-20 seconds], or other interval.

The wherein medium for recording programs enables a browser to implement the above computer program and to display the Web page in which an advertisement image is loaded. The wherein medium for recording programs also enables a browser to modify display attributes of the advertisement image in real time in order to accommodate other displayed contents. It is noted that, the computer-readable medium for recording programs in this invention can be any volatile or nonvolatile memory. Different storing method should not become the limit to present invention. In particular, the computer program recorded by the wherein medium for recording programs can be a plug-in. The plug-in can be automatically downloaded to the client through the Internet so as to make the browser realize corresponding function.

Thus, the present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Although embodiments of this invention has been shown and described in detail, it should be understood that many other variations from present invention may be made within the scope of the claims.

What is claimed is:

1. A method of loading advertisements in a Web page, comprising the steps of:
obtaining original image data from an original image file included in an original Web page;
integrating the original image data, display control parameters of the original image data, advertisement image data of at least one advertisement image, and display control parameters of the advertisement image into a new image file, wherein the display control parameters of the original image and the display control parameters of every advertisement image are respectively used to define how long the original image and corresponding advertisement image are displayed within every wherein; and
modifying said Web page by replacing said original image file with said new image file.

2. The method according to claim 1, wherein said original image is any moving/still image that is displayable in said Web page.

3. The method according to claim 1, wherein said original image is a background image of said Web page.

4. The method according to claim 1, wherein the display control parameters of at least one advertisement image are used to define that the advertisement image is displayed for a duration shorter than visual delay threshold within every second.

5. The method according to claim 1, wherein the steps are implemented on an advertisement proxy server, and further comprising a step of intercepting said Web page from the Internet and a step of sending the modified Web page to its destination address through the Internet

6. A proxy server for loading advertisements in a Web page, comprising the steps of:
obtaining a Web page including at least one image file, said image file containing data of at least two images and display control parameters of each image; and
alternately displaying each image for a duration that corresponds to the display control parameters of said image within every wherein.

7. The method according to claim 6, wherein one of said at least two images is a moving/still image that is displayable in said Web page.

8. The method according to claim 6, wherein one of said at least two images is a background image of said Web page.

9. The method according to claim 7, wherein the other one of said at least two images is an advertisement image.

10. The method according to claim 9, wherein said step of alternately displaying each image comprises: displaying said advertisement image for a duration shorter than visual delay threshold within every wherein.

11. The method according to claim 10, wherein each step is implemented on a browser, and further comprising an initial step of receiving said Web page from the Internet

12. The method according to claim 11, further comprising a step of modify display attributes of said advertisement image in real time in order to accommodate other displayed contents.

13. A proxy server for loading advertisements in a Web page, said proxy server comprising: an image extractor, for obtaining original image data from an original image file included in an original Web page;
an image file generator, for generating a new image file, and for integrating the original image data, display control parameters of the original image data, advertisement image data of at least one advertisement image, and display control parameters of the advertisement image into said new image fie, wherein the display control parameters of the original image and the display control parameters of every advertisement image are respectively used to define how long the original image and corresponding advertisement image are displayed within every second; and
a Web page modifying device, for modifying said Web page by replacing said original image file with said new image file.

14. The proxy server according to claim 13, wherein said image extractor obtains data of any moving/still image from said Web page as said original image data.

15. The proxy server according to claim 13, wherein said image extractor obtains data of a background image as said original image data.

16. The proxy server according to claim 13, wherein the display control parameters of at least one advertisement image are used to define that the advertisement image is displayed for a duration shorter than visual delay threshold within every second.

17. The proxy server according to claim 13, further comprising means for intercepting said Web page from the Internet and means for sending the modified Web page to its destination address through the Internet

18. An apparatus for displaying a Web page, said apparatus comprising:
means for obtaining a Web page including at least one image file, said image file containing data of at least two images and display control parameters of each image; and
means for alternately displaying each image for a duration that corresponds to the display control parameters of said image within every occurrence of a predetermined time interval.

19. The apparatus according to claim 18, wherein one of said at least two images is a moving/still image that is displayable in said Web page.

20. The apparatus according to claim 18, wherein one of said at least two images is a background image of said Web page.

21. The apparatus according to claim 19, wherein the other one of said at least two images is an advertisement image.

22. The apparatus according to claim 21, wherein said means for alternately displaying each image displays said advertisement image for a duration shorter than visual delay threshold within every second.

23. The apparatus according to claim 22, wherein said apparatus in a browser, and further comprises means for receiving said Web page from the Internet

24. The apparatus according to claim 23, further comprising means for modifying display attributes of said advertisement image in real time in order to accommodate other displayed contents.

25. A computer-readable medium for recording programs, wherein the computer programs recorded thereon are used for performing steps of:
obtaining original image data from an original image file included in an original Web page; integrating the original image data, display control parameters of the original image data, advertisement image data of at least one advertisement image, and display control parameters of the advertisement image into a new image file, wherein the display control parameters of the original image and the display control parameters of every advertisement image are respectively used to define how long the original image and corresponding advertisement image are displayed within every second, and
modifying said Web page by replacing said original image file with said new image file.

26. The medium for recording programs according to claim 25, wherein said original image in any moving/still image that is displayable in said Web page.

27. The medium for recording programs according to claim 26, wherein said original image is a background image of said Web page.

28. The medium for recording programs according to claim 27, wherein the display control parameters of at least one advertisement image are used to define that the advertisement image is displayed for a duration shorter than visual delay threshold within every second.

29. The medium for recording programs according to claim 25, wherein said medium for recording programs enables an advertisement proxy server to implement all the steps, and to implement an initial step of intercepting said Web page from the Internet and a final step of sending the modified Web page to its destination address through the Internet

30. A computer-readable medium for recording programs, wherein the computer programs recorded thereon are used for performing steps of:
obtaining a Web page including at least one image fie, said image file containing data of at least two images and display control parameters of each image; and
alternately displaying each image for a duration that corresponds to the display control parameters of said image within every occurrence of a predetermined time interval.

31. The medium for recording programs according to claim 30, wherein one of said at least two images is a moving/still image that is displayable in said Web page.

32. The medium for recording programs according to claim 30, wherein one of said at least two images is a background image of said Web page.

33. The medium for recording programs according to claim 31, wherein the other one of said at least two images is an advertisement image.

34. The medium for recording programs according to claim 33, wherein said step of alternately displaying each image comprises: displaying said advertisement image for a duration shorter than visual delay threshold within every second.

35. The medium for recording programs according to claim 34, wherein said medium for recording programs enables a browser to implement all the steps, and to implement an initial step of receiving said Web page from the Internet.

36. The medium for recording programs according to claim 35, further implementing a step of: modifying display attributes of said advertisement image in real time in order to accommodate other displayed contents.

37. An article of manufacture comprising a computer usable medium having computer readable program code means embodied therein for causing the loading of advertisements in a Web page, the computer readable program code means in said article of manufacture comprising computer readable program code means for causing a computer to effect the steps of claim 1.

38. An article of manufacture comprising a computer usable medium having computer readable program code means embodied therein for causing display of a Web page, the computer readable program code means in said article of manufacture comprising computer readable program code means for causing a computer to effect the steps of claim 6.

39. A program storage device readable by machine, tangibly embodying a program of instructions executable by the machine to perform method steps for causing the loading of advertisements in a Web page, said method steps comprising the steps of claim 1.

40. A program storage device readable by machine, tangibly embodying a program of instructions executable by the machine to perform method steps for causing display of a Web page,, said method steps comprising the steps of claim 6.

41. A computer program product comprising a computer usable medium having computer readable program code means embodied therein for causing functions of a proxy server, the computer readable program code means in said computer program product comprising computer readable program code means for causing a computer to effect the functions of claim 13.

42. A computer program product comprising a computer usable medium having computer readable program code means embodied therein for causing functions of an apparatus for displaying a Web page, the computer readable program code means in said computer program product comprising computer readable program code means for causing a computer to effect the functions of claim 19.
